(19) United States
(12) Patent Application Publication
(10) Pub. No.: US 2025/0377118 A1
(43) Pub. Date: Dec. 11, 2025

(54) METHOD FOR OPTIMIZING A DISTRICT HEATING NETWORK

(71) Applicant: Double M Properties Ab, Kokkola (FI)

(72) Inventor: Mats MANDERBACKA, Kokkola (FI)

(21) Appl. No.: 18/877,967

(22) PCT Filed: Jun. 23, 2022
(86) PCT No.: PCT/FI2022/050466

§ 371 Date: Dec. 20, 2024

(51) Int. Cl. F24D 10/00

(52) U.S. Cl. CPC F24D 10/00; F24D 2200/12; F24D 2200/13

(57) ABSTRACT

The invention relates to a method for optimizing a district heating network (1) comprising outgoing supply pipes and incoming return pipes, wherein a heat carrying fluid is circulated to be utilized for residential and commercial heating requirements. For storing excess thermal energy available at the district heating network. the method involves the steps of implementing more than one ground-based borehole thermal energy storage (4) as distributed heat storages at different locations of or along the district heating network (1). Each heat storage (4) is adapted to receive thermal energy from various forms of heat sources. which heat sources may be found at different locations of or along the district heating network (1) such, that the heat sources and the heat storages forming nodes in the district heating network (1). Excess thermal energy available to one node of the district heating network (1) is used to charge a borehole thermal energy storage (4) at one or several nodes, and thermal energy available from the borehole thermal energy storages (4) is at disposal to be used to heat the heat carrying fluid circulated in the supply pipes of the district heating network.

### FIELD OF THE INVENTION

The present invention relates to a method for optimizing a district heating network.

Such a district heating system is used for distributing heat generated in a centralized location through a distribution network of insulated pipes comprising outgoing supply pipes and incoming return pipes that circulate heated water, for residential and commercial heating requirements. The distributed heat is generally used for space heating and water heating via local heat exchangers. The centralized heat source typically comprises cogeneration plants burning fossil fuels or biomass. Due to climate requirements heat-only boiler stations, geothermal heating, heat pumps, central solar heating, as well as heat waste from industrial sites are also used.

### BACKGROUND OF THE INVENTION

As space heating is a seasonal phenomenon many of the heat generating plants are usually idle during the summer months and run for full capacity during the cold season. To administer the lack of heat generating plants especially during the summer months various forms of storage have been explored, such as storage in water tanks or boreholes, for instance, but such storages are not yet widely used due to several reasons. A main problem with water tanks, for instance, is that they have only a limited capacity and are primarily suitable for a short-term storage. Ground-based storage in boreholes on the other hand, is marred with big heat losses, which raises exponentially with increasing temperature of the stored energy.

A further problem relating to the district heating system is the centralized location of the heat generating plant. Due to this centralized location both the outgoing temperature of the circulated water as well as the pressure in the distribution network need to be high enough to be sufficient all over the network, even to most peripheral parts thereof. This limits the size of the district heating network and expansion is difficult. If peripheral areas are added, all the tubing down to the central location need to be increased in dimension. Alternatively, the pressure and outgoing temperature need to be increased, making a storage providing a decreasing temperature disadvantageous.

### BRIEF DESCRIPTION OF THE INVENTION

It is thus an object of the present invention to provide a method so as to overcome the above problems.

The objects of the invention are achieved by a method which is characterized by what is stated in the independent claim 1. The preferred embodiments of the invention are disclosed in the dependent claims.

The invention is based on the idea of implementing distributed storages as ground-based borehole storages at strategic locations of the district heating network. Such a storage would preferably comprise several nested rings of boreholes providing a field of outwards diminishing temperature (Borehole Thermal Energy Storage, hereby abbreviated “BTES”). To ensure a sufficient heat supply, heat pumps will be used to raise the heat in a central location of the field of boreholes. Furthermore, a controller unit will be assigned to monitor the temperature in the outgoing pipes and returning pipes of the district heating network as well as to monitor the temperatures of the different rings of the borehole field, and the price of electricity. This monitoring allows the controller unit to regulate heat distribution within the district heating network and the heat storages thereof in the most cost-effective way.

Thus, already existing district heating systems can easily be converted to a distribution system according to the present invention utilizing decentralized heat storages and heat sources.

The present invention also makes it possible to realize networks having circulating water of different temperatures depending on the demand and requirements.

Excess thermal energy available at one location of the network, can thereby be used to charge the Borehole Thermal Energy Storages (BTES) at other nodes, either directly or using an intermediate heat pump.

### BRIEF DESCRIPTION OF THE DRAWINGS

In the following the invention will be described in greater detail by means of the preferred embodiment with reference to the attached drawings, in which

FIG. 1 illustrates a prior art district heating network,

FIG. 2 illustrates district heating network according to the present invention, and

FIG. 3 illustrates a part of the district heating network of FIG. 2, a BTES connected to the district heating network and the control of circulating heat carrying fluid therein.

### DETAILED DESCRIPTION OF THE INVENTION

The above figures do not show the method for optimizing a district heating network in scale but have only the task of illustrating the solutions of the preferred embodiment and the function of thereof. Parts shown in the accompanying figures and marked with reference numerals correspond to the parts presented in the following description.

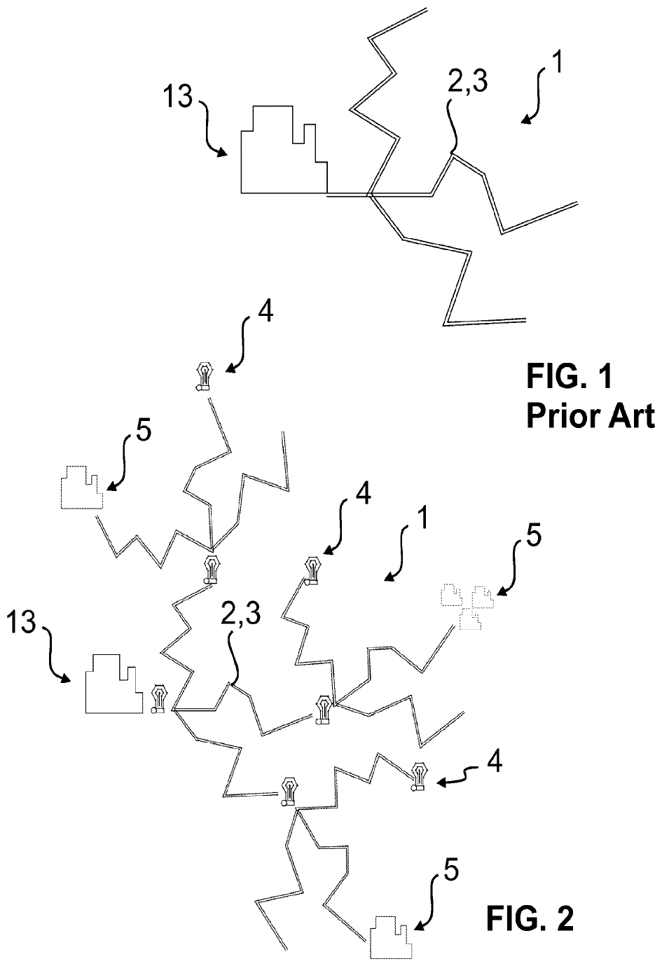

A typical prior art district heating network is illustrated by FIG. 1. Such a network is used for distributing heat generated in a centralized heat generating plant 13. The heat generated is distributed through network of insulated pipes comprising outgoing supply pipes 2 and incoming return pipes 3. This network circulates a heat carrying fluid such as heated water to be utilized for residential and commercial heating requirements at locations along the network.

Referring now to FIG. 2, it illustrates a district heating network 1 comprising various heat storages 4 and heat sources 5 to be found at different locations of or along the district heating network 1. These heat storages 4 and heat sources 5 are hereinafter referred to as “nodes” and are preferably connected to the insulated outgoing supply pipes 2 of said network but may also be connected to the insulated incoming return pipes 3, both of the pipes circulating a heat carrying fluid. These heat storages 4 and heat sources 5 can be of various sizes and capacity, and the heat storages 4 may be formed as ground-based Borehole Thermal Energy Storages (BTES). Such BTESs 4 can, depending on the heat distribution requirements along the district heating network 1 at a given moment, also provide thermal energy to the district heating network 1 or to the other heat storages 4 along the district heating network 1. If an existing central heat generating plant is available, this will form one of the several nodes in the present heat distribution system. The heat sources 5 may also include, for example, smaller supplementary power plants of various types along the district heating network 1.

According to the present solution, the BTESs 4 are installed at strategic locations along the district heating network 1. The location of each BTES is chosen according to the availability of space for building the storage, the energy demand, as well as by the availability of local heat sources.

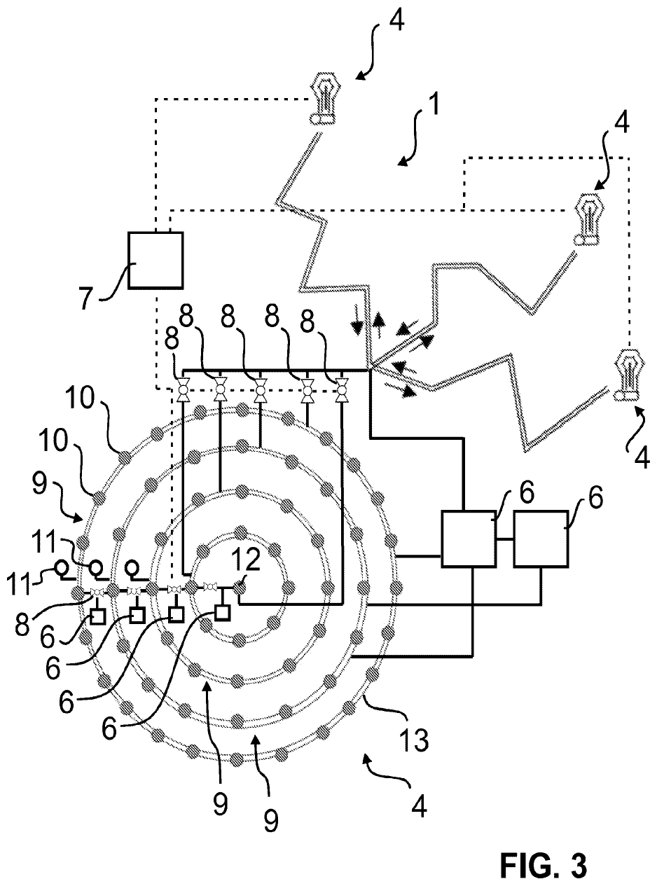

Referring now to FIG. 3, it illustrates schematically the structure of a singular BTES 4, as well as some of its possible connection options to the district heating network of FIG. 2. Said connection options are illustrated in FIG. 3 in a simplified manner, and some of possible connections between, for example, different parts of the BTES 4 and a controller unit 7 are not illustrated in the figure for the sake of clarity. Some of the illustrated parts, such as the heat pumps 6 may also be alternative to each other by nature and may or may not be included in the system simultaneously. Also, the BTES 4, the district heating network 1 and the other components of the heating network system illustrated in the figure do not represent their actual relative sizes.

Any excess thermal energy available in the district heating network 1 including the heat sources 5 connected thereto, can be used to charge the BTESs 4, either directly or using an intermediate heat pump 6. Primarily such excess thermal energy is available from the heat carrying fluid circulated in the outgoing supply pipes 2 of the district heating network 1 but may also be available from the heat carrying fluid circulated in the incoming return pipe 3 of the district heating network. In this context, charging of the BTESs means that the thermal energy available in the district heating network 1 is used to increase the temperature of the BTESs.

Each BTES 4 is connected to the district heating network 1 by one or several heat pumps 6. The heat pumps 6 are arranged to be regulated by a controller unit 7, which manages a series of valves 8. These valves 8 control both the outgoing and incoming heat carrying fluid, primarily water. The heat carrying fluid is circulated to the heat pump 6, hereby transporting thermal energy between the pipes of the district heating network 1 and the borehole thermal energy storage 4. Thus, the thermal energy previously stored in the BTESs 4 is at disposal to be used to heat the heat carrying fluid circulated in the supply pipes 2 of the district heating network 1 whenever needed. The controller unit 7 may also be arranged to regulate the heat pumps 6 such that excess thermal energy available at the incoming return pipes 3 is transferred directly back to the outgoing supply pipes 2. In situations where the temperature available directly from a BTES 4 is sufficiently high, using a heat pump 6 for heat transfer from the BTES to the heat carrying fluid circulated in the supply pipes 2 may not be necessary.

According to the present solution, the controller unit 7 is adapted to continuously monitor the momentary cost of electricity, the temperature of the heat carrying fluid circulated in the outgoing supply pipes 2 and the incoming return pipes 3 of the district heating network 1, as well as the temperature in each of nested rings 9 of boreholes 10 in each of the borehole thermal energy storages 4, and thermal energy consumption along the district heating network 1 at each moment. The controller unit 7 may also incorporate weather forecasts in the monitoring, hereby adjusting the predicted thermal energy demand of the district heating network 1.

Additionally, the controller unit 7 may estimate the amount of thermal energy available from each BTES 4 based on its thermal response to, for example, thermal energy being supplied to it. Said thermal response may be related to, for example, the rate at which the temperature of the BTES 4 changes in response to the supplied thermal energy, or the temperature to which the BTES 4 stabilizes at a pre-determined time period after the supply of thermal energy has been cut. This way, an improved estimation of the thermal energy distribution over the district heating network 1 may be provided for more accurate thermal energy management.

Based on the monitored information, the controller unit 7 is adapted to regulate the heat pump or pumps 6 either to import excess thermal energy to the BTESs 4 or to export thermal energy from the BTESs 4. The controller unit 7 may be operated through, for example, a cloud-based software and be accessible from a remote location.

Said rings 9 of boreholes 10 are composed of a number of boreholes 10 arranged in, for example, a circular formation and connected to each other by a conduit system 13 distributing the heat carrying fluid. In some implementations of the BTES 4, said conduit system 13 can also on its own act as a thermal energy storing component forming the rings 9, reducing or even eliminating the need for separate boreholes 10.

While monitoring the temperature of the different boreholes 10 or rings 9 of boreholes 10 of the BTESs 4, the controller unit 7 may also control the flow of the heat carrying fluid distributed to or received from the several nested rings 9 of boreholes 10 forming the borehole thermal energy storage 4. Said control may also take place through valves 8 managed by the controller unit 7. The control unit 7 will hereby ensure that an outwards successively diminishing temperature will be upheld in the boreholes of the BTES 4. This way the temperature in a central location of a BTES 4 may at any moment be increased by circulating heat from the outer boreholes 10 or borehole rings 9 thereof, preferably using a heat pump 6 to reach the target temperature of said central location. With said arrangement, the outer rings 9 of boreholes 10 act as a thermal buffer between the central location having a higher temperature, and the surrounding environment of the BTES 4 having a lower temperature, reducing the loss of stored thermal energy due to uncontrolled heat dissipation. Another advantage of said arrangement is that also heat carrying fluid having a temperature too low for efficient heat transfer to the district heating network 1, may be utilized at the outer rings 9 of boreholes for the described energy preservation purposes.

Each of the several nested rings 9 of boreholes 10 may be adapted to connect to the district heating network 1 and to the other rings 9 of boreholes within the borehole thermal energy storage by one or several heat pumps 6. In addition to, or in some instances instead of the heat pumps 6, the rings 9 of boreholes 10 may also be adapted to connect to a heater 11. This way, available electricity may also be used to charge the BTESs through the heaters 11 when the price of electricity is on a suitable level.

### EXAMPLES

The following basic operational modes of the present method for optimizing a district heating network can be identified.

In the summertime, when the heat demand of the district heating network 1 is low, some or all of the excess heat can be stored directly in one or more of the BTESs 4.

When the price of electricity is below a set trigger value, one or more of the heat pumps 6 connected to BTESs 4 will start. The heat pumps 6 will now be used to heat the heat carrying fluid imported from the district heating network 1 and deliver this thermal energy to one or more of the rings 9 of boreholes 10 of the BTES 4. In some instances, also the heaters 11 may be used for delivering thermal energy to the rings 9 of boreholes 10 of the BTES 4. If there is registered a heat demand in the district heating network 1, thermal energy may also be delivered by the heat pumps 6 to the district heating network.

When the heat carrying fluid circulated in the district heating network 1 has a sufficient temperature, requiring no measures to be taken the heat pump 6 of a BTES 4 will circulate thermal energy from the outer rings 9 of the BTES 4 to the central location thereof as to maintain the target temperature thereof.

Each heat pump 6 typically has an optimal operational range. In other words, each heat pump 6 is set to perform most efficiently within a given range of input and output temperatures. The controller unit 7 will optimize the performance of the BTES 4 by applying a heat pump 6 depending on its performance characteristics. That is, in each situation the controller unit 7 will choose a heat pump 6 from the available heat pumps 6 that has the most suitable performance characteristics for the thermal conditions in the given situation. Each ring 9 of boreholes 10 can be applied either as a source or an output for the heat pump 6, meaning that the thermal energy carried by the heat carrying fluid can be directed to or from any of the rings 9 of boreholes 10 by the heat pump 6. The controller unit 7 can therefore be applied to either establish a connection directly between each one of the nested rings 9 of boreholes 10 and a centre borehole 12 of the borehole thermal energy storage 4, or to establish a connection between each consecutive ring 9 of boreholes 10. In this way the temperature range and the efficiency of the heat pump can be optimized.

Several heat pumps 6 can also be connected in series so as to act within a preferred temperature range.

It will be obvious to a person skilled in the art that, as the technology advances, the inventive concept can be implemented in various ways. The invention and its embodiments are not limited to the examples described above but may vary within the scope of the claims.

Different regional district heating networks may also be applied to function as storages of thermal energy at a national or an international basis. These district heating networks will form local heatsinks thus balancing and optimizing the load on the electricity network or networks.

1-15. (canceled)

16. A method for optimizing a district heating network comprising outgoing supply pipes and incoming return pipes, wherein a heat carrying fluid is circulated to be utilized for residential and commercial heating requirements, comprising the steps
implementing more than one ground-based borehole thermal energy storage as distributed heat storages at different locations of or along the district heating network; whereby
each heat storage is adapted to receive thermal energy from various forms of heat sources, which heat sources may be found at different locations of or along the district heating network such, that
the heat sources and the heat storages forming nodes in the district heating network, whereby excess thermal energy available to one node of the district heating network is used to charge a borehole thermal energy storage at one or several nodes, and
thermal energy available from the borehole thermal energy storages is at disposal to be used to heat the heat carrying fluid circulated in the supply pipes of the district heating network, wherein a controller unit is adapted to regulate the flow of the heat carrying fluid circulated in the borehole thermal energy storages, whereby
the controller unit controls valves regulating the flow of the heat carrying fluid transporting thermal energy between the pipes of the district heating network and the borehole thermal energy storage,
the controller unit furthermore controls the flow of the heat carrying fluid distributed to or received from several nested rings of boreholes forming the borehole thermal energy storage, the nested rings of boreholes providing a field of outwards successively diminishing temperature in the borehole thermal energy storage, wherein
each of the several nested rings of boreholes is adapted to connect to the district heating network and to the other rings of boreholes of the borehole thermal energy storage by at least one heat pump.

17. A method according to claim 16, wherein excess thermal energy is received from the heat carrying fluid circulated in the outgoing supply pipe of the district heating network.

18. A method according to claim 16, wherein excess thermal energy is received from the heat carrying fluid circulated in the incoming return pipe of the district heating network.

19. A method according to claim 16, wherein each borehole thermal energy storage is adapted to connect to the district heating network by at least one heat pump.

20. A method according to claim 16, wherein each of the several nested rings of boreholes is adapted to connect to a heater.

21. A method according to claim 16, wherein the controller unit is adapted to continuously monitor:
momentary cost of available electricity,
temperature of the heat carrying fluid circulated in the outgoing supply pipes and the incoming return pipes of the district heating network,
temperature in each of the nested rings of boreholes in each of the borehole thermal energy storages, and
thermal energy consumption along the district heating network at each moment, whereby based on the monitored information the controller unit is adapted to regulate the at least one heat pump either to import thermal energy to the borehole thermal energy storages or to export thermal energy from the borehole thermal energy storages depending on:
a set trigger value of price of available electricity, and
the predicted thermal energy demand along the district heating network.

22. A method according to claim 16, wherein the temperature in a central location of the nested rings of boreholes forming the borehole thermal energy storage may at any moment be increased by circulating heat from outer rings thereof.

23. A method according to claim 16, wherein the temperature in a central location of the nested rings of boreholes forming the borehole thermal energy storage may at any moment be increased by circulating heat from outer rings thereof, and
the at least one heat pump is adapted to raise the temperature of the heat carrying fluid transporting thermal energy from the outer rings to the central location of the nested rings of boreholes forming the borehole thermal energy storage.

24. A method according to claim 16, wherein the temperature in a central location of the nested rings of boreholes forming the borehole thermal energy storage may at any moment be increased by circulating heat from outer rings thereof, and the at least one heat pump is adapted to raise the temperature of the heat carrying fluid transporting thermal energy from the outer rings to the central location of the nested rings of boreholes forming the borehole thermal energy storage, and
when raising the temperature in the central location of the nested rings of boreholes forming the borehole thermal energy storage, the controller unit is adapted to apply a heat pump depending on the performance characteristics thereof.

25. A method according to claim 16, wherein each of the rings of boreholes of a borehole thermal energy storage can be applied either as a source or an output for the at least one heat pump.

26. A method according to claim 16, wherein each of the rings of boreholes of a borehole thermal energy storage can be applied either as a source or an output for the at least one heat pump, and
the controller unit can be applied to either establish a connection directly between each one of the nested rings of boreholes and a centre borehole of the borehole thermal energy storage, or to establish a connection between each consecutive ring of boreholes, as to maintain the target temperatures thereof.

27. A method according to claim 16, wherein several heat pumps are adapted to work in series so as to ensure each of the heat pumps to act within a preferred temperature range.

28. A method according to claim 16. wherein the controller unit is adapted to estimate the amount of thermal energy available from each borehole thermal energy storage based on its thermal response to thermal energy being supplied to it.
